(19) United States
(12) Patent Application Publication
(10) Pub. No.: US 2026/0262728 A1
(43) Pub. Date: Sep. 10, 2026

(54) HEATING MEMBER AND ATOMIZATION APPARATUS

(71) Applicant: HUMBLE GRACE LIMITED, Hong Kong (CN)

(72) Inventors: Yao FU, Hong Kong (CN); Xinyang YAN, Hong Kong (CN); Liucheng CHEN, Hong Kong (CN); Zhichao CHEN, Hong Kong (CN); Tao HAI, Hong Kong (CN)

(21) Appl. No.: 19/663,319

(22) Filed: Apr. 30, 2026

Related U.S. Application Data
(63) Continuation of application No. PCT/CN2024/086036, filed on Apr. 3, 2024.

(30) Foreign Application Priority Data
Dec. 14, 2023 (CN) 202323417169.0

(51) Int. Cl. A24F 40/46; A24F 40/10; A24F 40/485; H05B 3/03

(52) U.S. Cl. CPC A24F 40/46; A24F 40/10; A24F 40/485; H05B 3/03

(57) ABSTRACT

This application provides a heating member and an atomization apparatus, where the heating member includes a heating portion and an electrode portion. The heating portion is wound and enclosed to form a tubular structure, and the heating portion is provided with a plurality of recessed portions and/or a plurality of protruding portions. The recessed portions are bent inward in a radial direction of the tubular structure, and the protruding portions are bent outward in the radial direction of the tubular structure. The electrode portion is connected to the heating portion.

### CROSS-REFERENCE OF RELATED APPLICATIONS

This application is a national stage filing under 35 U.S.C. § 371 of international application number PCT/CN 2024/086036, filed on Apr. 3, 2024, which claims priority to Chinese patent application No. 202323417169.0, filed on Dec. 14, 2023. The contents of these applications are incorporated herein by reference in their entireties.

### TECHNICAL FIELD

This application relates to the field of electronic atomization apparatuses, and in particular, to a heating member and an atomization apparatus.

### BACKGROUND

In an electronic atomization apparatus product, a heating member is usually used to heat an aerosol generation substrate, so that the aerosol generation substrate generates aerosol for use by a user. The heating member employing a surface heating manner has a relatively large overall heating area, but an atomization explosive force of the heating member is relatively poor when heating power is not increased, making it difficult to achieve high levels of nicotine and total particulate matter (Total Particulate Matter, TPM for short) in vapor in an electronic atomizer, as well as a large vapor output.

### SUMMARY

This application provides a heating member and an atomization apparatus, and the heating member has a relatively large atomization explosive force.

To resolve the foregoing technical problem, this application provides a heating member, where the heating member includes a heating portion and an electrode portion. The heating portion is wound and enclosed to form a tubular structure, and the heating portion is provided with a plurality of recessed portions and/or a plurality of protruding portions. The recessed portions are bent inward in a radial direction of the tubular structure, and the protruding portions are bent outward in the radial direction of the tubular structure. The electrode portion is connected to the heating portion.

In an embodiment, the plurality of recessed portions or the plurality of protruding portions are disposed at intervals; or in the plurality of recessed portions and the plurality of protruding portions, the recessed portions and the protruding portions are alternately disposed.

In an embodiment, the plurality of recessed portions or the plurality of protruding portions are arranged at intervals; or in the plurality of recessed portions and the plurality of protruding portions, the recessed portions and the protruding portions are alternately arranged.

In an embodiment, the heating portion further includes a main body portion. The main body portion is connected to the recessed portion and/or the protruding portion, and the main body portion is parallel to an axial direction of the tubular structure.

In an embodiment, the heating portion is a mesh structure. The heating portion includes a plurality of heating units, and the heating unit is provided with a hollowed-out hole. A plurality of the heating units are arranged in an array and connected to each other to form the mesh structure.

In an embodiment, the heating unit is a diamond-shaped structure, and adjacent diamond-shaped structures are connected at endpoints. The diamond-shaped structure includes an upper endpoint, a lower endpoint, a left endpoint, and a right endpoint. The recessed portion or the protruding portion includes a first wall surface and a second wall surface, and the first wall surface and the second wall surface are connected and disposed opposite to each other. The upper endpoint and the lower endpoint, and either the left endpoint or the right endpoint of the diamond-shaped structure are located at a connection position between the first wall surface and the second wall surface.

In an embodiment, the recessed portion or the protruding portion is a curved surface structure. Alternatively, the recessed portion or the protruding portion includes a first wall surface and a second wall surface, and the first wall surface and the second wall surface are connected and disposed opposite to each other.

In an embodiment, the recessed portion or the protruding portion includes the first wall surface and the second wall surface. An included angle is formed between the first wall surface and the second wall surface, and the included angle ranges from 10° to 130°.

In an embodiment, in an axial direction of the heating member, the heating member includes a plurality of rows of heating unit groups, and each row of heating unit groups includes a plurality of heating units sequentially connected in a circumferential direction of the heating member.

In an embodiment, the heating portion includes a main heating portion and a wiring portion. The main heating portion is provided with a plurality of recessed portions and/or protruding portions, the electrode portion is connected to the wiring portion, and a thermal stress relief hole is provided at a connection position between the main heating portion and the wiring portion.

In an embodiment, the heating portion includes a main heating portion and a plurality of heat conducting portions, and the main heating portion is provided with a plurality of recessed portions and/or protruding portions. In an axial direction of the heating member, the main heating portion has a first end and a second end that are opposite to each other. The heat conducting portions are connected to the first end and/or the second end of the main heating portion, and the heat conducting portions extend in the axial direction of the heating member.

To resolve the foregoing technical problem, this application further provides an atomization apparatus, including the heating member in any one of the foregoing embodiments.

In an embodiment, the atomization apparatus further includes a liquid storage member, a sleeve, and a liquid guide member. The liquid storage member, the sleeve, the heating member, and the liquid guide member are sequentially nested from the outside to the inside. The sleeve is provided with a liquid inlet hole, and two sides of the liquid inlet hole respectively communicate with the heating member and the liquid storage member. A heating portion of the heating member is provided with a plurality of recessed portions, and at least a part of the recessed portion is inserted into the liquid guide member.

In an embodiment, an aerosol generation substrate is atomized into aerosol in the sleeve. One end of the sleeve is an aerosol outlet of the sleeve, and the other end of the sleeve is provided with an air inlet. A side of the sleeve close to the air inlet is provided with a plurality of liquid inlet holes, and the heating member is disposed at an end of the sleeve provided with the liquid inlet holes.

In some embodiments, the liquid guide member is a porous structure that can absorb e-liquid.

In the heating member and the atomization apparatus in this application, the heating member includes the heating portion and the electrode portion. The heating portion is wound and enclosed to form the tubular structure, and the heating portion is provided with the plurality of recessed portions and/or the plurality of protruding portions. The recessed portions are bent inward in a radial direction of the tubular structure, and the protruding portions are bent outward in the radial direction of the tubular structure. The electrode portion is connected to the heating portion, and the electrode portion is configured to be electrically connected to a power supply. In the heating member in this application, the heating portion is provided with the recessed portion and/or the protruding portion. The recessed portion and/or the protruding portion is a bent or curved structure formed by bending inward or outward in the radial direction of the tubular structure. The bent or curved structure may induce secondary radiation of heat, thereby achieving an effect of secondary utilization of heat. In this way, a local temperature at the recessed portion and/or the protruding portion is increased, convective heat loss between the heating member and air is reduced, and an atomization explosive force and TPM are improved.

### BRIEF DESCRIPTION OF DRAWINGS

FIG. 1 is a schematic structural diagram of an atomization apparatus according to an embodiment of this application;

FIG. 2 is a schematic diagram of an exploded structure of FIG. 1;

FIG. 3 is a schematic structural diagram of a heating member according to an embodiment of this application;

FIG. 4 is a schematic structural diagram of the heating member of FIG. 3 in an expanded state;

FIG. 5 is a schematic diagram of a surface of a part of a structure of a heating member according to an embodiment of this application;

FIG. 6 is a schematic diagram of a surface of a part of a structure of a heating member according to another embodiment of this application; and

FIG. 7 is a schematic diagram of a surface of a part of a structure of a heating member according to still another embodiment of this application.

### DESCRIPTION OF EMBODIMENTS

The following further describes this application in detail through specific implementations with reference to the accompanying drawings. Associated and similar reference numerals are used for similar elements in different implementations. In the following implementations, many details are described so that this application can be better understood. However, a person skilled in the art may readily recognize that some of the features may be omitted in different cases, or may be replaced by another element, material, or method. In some cases, some operations related to this application are not shown or described in this specification to avoid obscuring a core part of this application with excessive description. For a person skilled in the art, a detailed description of the related operations is not necessary. A person skilled in the art can fully understand the related operations based on the description in the specification and general technical knowledge in the art.

In addition, the characteristics, operations, or features described in the specification may be combined in any appropriate manner to form various implementations, and operation steps used in each embodiment may also be sequentially switched or adjusted in a manner obvious to a person skilled in the art. Therefore, the specification and the accompanying drawings are merely intended to clearly describe an embodiment, and do not imply a necessary composition and/or sequence.

Sequence numbers in this specification, such as “first” and “second”, are only used for distinguishing described objects, and do not have any sequence or technical meaning. The terms “connected” and “coupled” used in this application, unless otherwise specified, include both direct and indirect connections (or couplings).

This application provides an atomization apparatus, and the atomization apparatus may be configured to atomize an aerosol generation substrate. The atomization apparatus includes a heating member 10, and the heating member 10 is configured to heat and atomize the aerosol generation substrate to generate aerosol. The heating member 10 may be a heating member 10 described in any one of the following embodiments.

The atomization apparatus may further include a battery that supplies power to the heating member 10. Alternatively, the atomization apparatus may be detachably assembled with and electrically connected to a power supply component. Certainly, in some embodiments, the atomization apparatus may be disposed integrally with the power supply component. The power supply component may be a battery, and the power supply component supplies power to the heating member 10. The atomization apparatus may further include a controller, or the atomization apparatus may be electrically connected to a controller of an external power supply assembly. After receiving a start signal, the controller controls the battery to supply power to the heating member 10 and controls heating power, heating duration, and the like of the heating member 10.

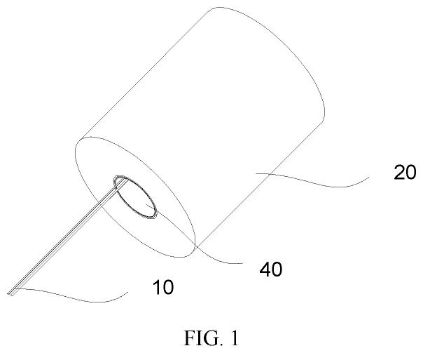

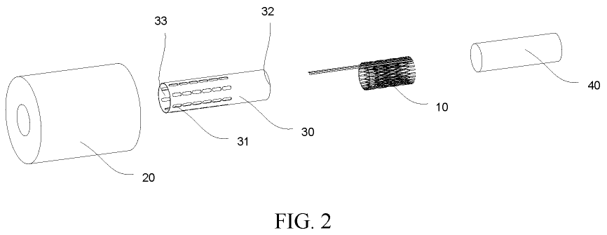

As shown in FIG. 1 and FIG. 2, the atomization apparatus may further include a liquid storage member 20, a sleeve 30, and a liquid guide member 40. The liquid storage member 20 is configured to store an aerosol generation substrate, and the aerosol generation substrate may be, for example, e-liquid or medical solution. The liquid storage member 20 is usually a porous structure. For example, the liquid storage member 20 may be e-liquid storage cotton or porous ceramic. Each of the liquid storage member 20, the sleeve 30, and the heating member 10 may be of a tubular structure. An interior of the tubular structure has a cavity, and two ends of the cavity are open. Further, a shape of the tubular structure is cylindrical, and the cavity inside the tubular structure is also cylindrical. The liquid storage member 20, the sleeve 30, the heating member 10, and the liquid guide member 40 are sequentially nested from the outside to the inside.

The sleeve 30 is provided with a liquid inlet hole 31. Two sides of the liquid inlet hole 31 respectively communicate with the heating member 10 and the liquid storage member 20. In an embodiment, there may be a plurality of liquid inlet holes 31, for example, at least two. When there is a relatively large quantity of liquid inlet holes 31, e-liquid exchange efficiency of the atomization apparatus can be improved. As shown in FIG. 2, a plurality of liquid inlet holes 31 may be arranged in an array and uniformly distributed on the sleeve 30 in a circumferential direction. Further, an aerosol generation substrate is atomized into aerosol in the sleeve 30. One end of the sleeve 30 is an aerosol outlet 32 of the sleeve 30, and the other end of the sleeve 30 is provided with an air inlet 33. A side of the sleeve 30 close to the air inlet 33 is provided with a plurality of liquid inlet holes 20. In other words, the plurality of liquid inlet holes 31 may be distributed, as shown in FIG. 2, only in middle and lower portions of the sleeve 30. The heating member 10 is disposed at an end of the sleeve 30 provided with the liquid inlet holes 31. The air inlet 33 of the sleeve 30 may communicate with an air intake channel of the atomization apparatus, and the aerosol outlet 32 of the sleeve 30 may communicate with an air outlet channel of the atomization apparatus, so that an airflow can enter an interior of the sleeve 30 from the air intake channel of the atomization apparatus via the air inlet 33 of the sleeve 30, carry aerosol atomized in the sleeve 30, flow from the aerosol outlet 32 of the sleeve 30 into the air outlet channel of the atomization apparatus, and finally flow out of the atomization apparatus to be inhaled by a user. The liquid inlet holes 31 are disposed at an end of the sleeve 30 close to the air inlet 33, so that the aerosol generation substrate can be fully atomized into aerosol, to prevent liquid from the liquid storage member 20 from leaking over a large area into the interior of the sleeve 30, which causes the user to inhale the e-liquid.

The liquid guide member 40 may be disposed to be attached to the interior of the tubular structure of the heating member 10. The liquid guide member 40 may direct the aerosol generation substrate to various parts of the heating member 10, to increase a flowing speed of liquid on an inner surface of the heating member 10, thereby improving energy utilization and atomization efficiency of the heating member 10. In an embodiment, the liquid guide member 40 has a porous structure, which can adsorb a substance such as e-liquid and enable an airflow to pass through pores of the liquid guide member 40. For example, the liquid guide member 40 may be e-liquid guide cotton.

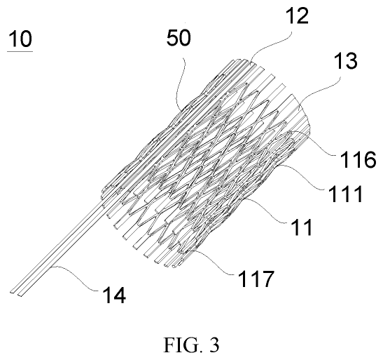

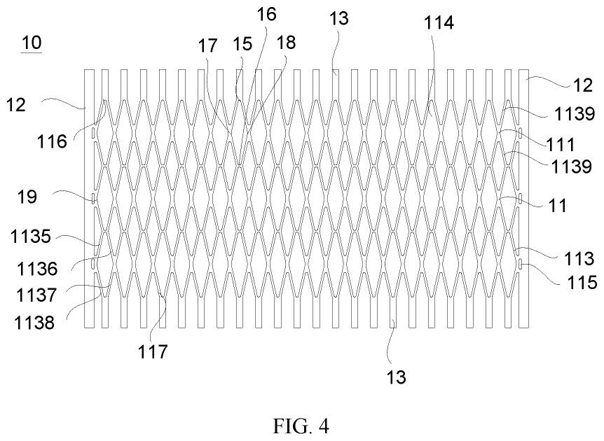

As shown in FIG. 3 to FIG. 7, this application further provides a heating member 10. The heating member 10 includes a heating portion 11 and an electrode portion 14. The heating portion 11 is wound and enclosed to form a tubular structure. In other words, the heating portion 11 in FIG. 4 may be wound to form the tubular structure as shown in FIG. 3. After the heating member 10 atomizes an aerosol generation substrate on a surface of the heating member 10 into aerosol, the aerosol passes through the liquid guide member 40 inside the tubular structure and finally flows out of the atomization apparatus with an airflow for use by the user.

Generally, the heating portion 11 includes a main heating portion 50 and a wiring portion 12. The main heating portion 50 may include, for example, a recessed portion 111 and/or a protruding portion 112 and a main body portion 1139 described below. There are two wiring portions 12. One wiring portion 12 is connected to one end portion of the main heating portion 50 in a circumferential direction, and the other wiring portion 12 is connected to the other end portion of the main heating portion 50 in the circumferential direction. The wiring portions 12 are connected to the electrode portion 14, so that when the electrode portion 14 can be connected to the heating portion 11, the electrode portion 14 is configured to be electrically connected to a power supply. In this way, a current flows in a circumferential direction of the heating portion 11, so that the heating portion 11 can generate heat when being energized, thereby heating an aerosol generation substrate to generate aerosol.

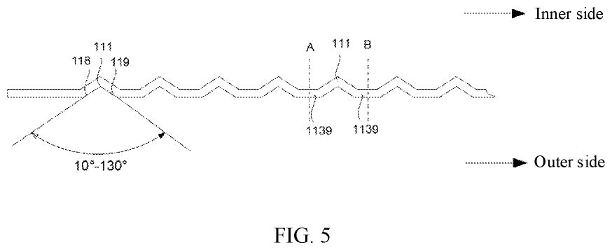

The heating portion 11 is provided with a plurality of recessed portions 111 and/or a plurality of protruding portions 112. Refer to FIG. 3, and FIG. 5 to FIG. 7, an upper side of each graph in FIG. 5 to FIG. 7 may be considered as an inner side of the tubular structure of the heating member 10, and a lower side of the graph may be considered as an outer side of the tubular structure of the heating member 10. In other words, in the graph in FIG. 5 to FIG. 7, a line close to the inner side is an inner surface of the heating member 10, and a line close to the outer side is an outer surface of the heating member 10.

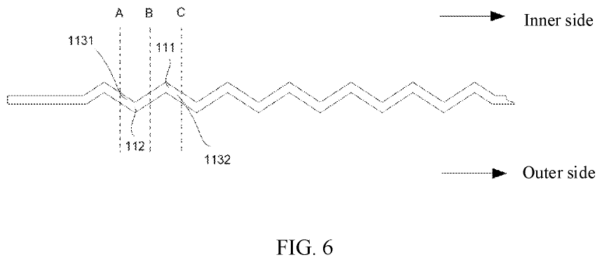

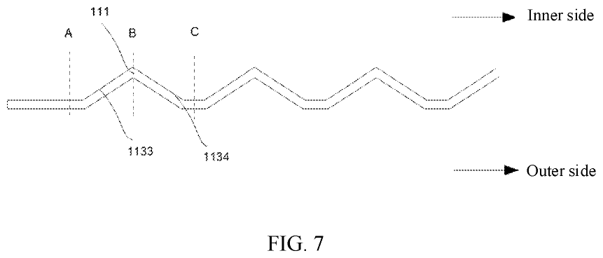

As shown in FIG. 3, and FIG. 5 to FIG. 7, the recessed portion 111 of the heating portion 11 is bent inward in a radial direction of the tubular structure. In other words, a part of the structure of the heating portion 11 is recessed toward the interior of the tubular structure to form the recessed portion 111. In FIG. 3, FIG. 5, and FIG. 7, the protruding portion 112 is not provided. In FIG. 6, the protruding portion 112 is provided. The protruding portion 112 of the heating portion 11 is bent outward in the radial direction of the tubular structure. In other words, a part of the structure of the heating portion 11 protrudes toward an exterior of the tubular structure to form the protruding portion 112. Usually, when the recessed portion 111 or the protruding portion 112 on the heating portion 11 is manufactured, the recessed portion 111 or the protruding portion 112 may be formed through stamping on a smooth heating portion 11.

In the heating member 10 in this application, the heating portion 11 is provided with the recessed portion 111 and/or the protruding portion 112. Both the recessed portion 111 and the protruding portion 112 are bent or curved structures formed by surface recessing of the tubular structure. The bent or curved structure may induce secondary radiation of heat, thereby achieving an effect of secondary utilization of heat. In this way, a local temperature at the recessed portion 111 and/or the protruding portion 112 is increased, convective heat loss between the heating member 10 and air entering the interior of the heating member from the air inlet 33 of the sleeve is reduced, and an atomization explosive force and TPM are improved. The heating member may be applicable to a high-power atomization apparatus with a power range of 12 W to 15 W.

In addition, when the heating member 10 is provided with the recessed portions 111, the recessed portions 111 may be inserted into the liquid guide member 40 inside the heating member 10, thereby making a connection between the heating member 10 and the liquid guide member 40 more stable and tighter, and promoting liquid guiding and atomization of an aerosol generation substrate in the liquid guide member 40.

In an embodiment, the plurality of recessed portions 111 or the plurality of protruding portions 112 are disposed at intervals (for example, as shown in FIG. 5). In other words, when the heating portion 11 is provided with only the plurality of recessed portions 111, the plurality of recessed portions 111 are spaced from each other. When the heating portion 11 is provided with only the plurality of protruding portions 112, the plurality of protruding portions 112 are spaced from each other.

When the heating portion 11 is provided with the plurality of recessed portions 111 and the plurality of protruding portions 112, the recessed portions 111 may be spaced from each other, the protruding portions 112 may be spaced from each other, or the recessed portions 111 may be spaced from the protruding portions 112.

Certainly, in another embodiment, the plurality of recessed portions 111 or the plurality of protruding portions 112 may alternatively be connected continuously, or the plurality of recessed portions 111 and the plurality of protruding portions 112 may be connected continuously (as shown in FIG. 6). Alternatively, a part of the recessed portions 111 are disposed dispersedly and at intervals, and another part of the recessed portions 111 are connected continuously; a part of the protruding portions 112 are disposed dispersedly and at intervals, and another part of the protruding portions 112 are connected continuously; or a part of the recessed portions 111 and a part of the protruding portions 112 are disposed dispersedly and at intervals, and another part of the recessed portions 111 and another part of the protruding portions 112 are connected continuously. A disposing manner of the recessed portions 111 and protruding portions 112 may be determined as needed and is not limited to the foregoing disposing manners.

In an embodiment, the recessed portions 111 and the protruding portions 112 are alternately disposed. “Alternately” may refer to being alternately arranged in a regular manner that can be contemplated such as ABAB or AABBAABB. Certainly, “alternately” may alternatively refer to being alternately arranged in an irregular manner.

In any one of the foregoing embodiments, the plurality of recessed portions 111 or the plurality of protruding portions 112 may be arranged, or the plurality of recessed portions 111 and the plurality of protruding portions 112 may be arranged. “Arranged” refers to an arrangement manner of forming one horizontal column or a plurality of horizontal columns or one vertical column or a plurality of vertical columns. For example, the plurality of recessed portions 111 or the plurality of protruding portions 112 may be arranged at intervals, or in the plurality of recessed portions 111 and the plurality of protruding portions 112, the recessed portions 111 and the protruding portions 112 are alternately arranged. Arrangement may be uniform arrangement. Uniformly arranging the recessed portions 111 and/or the protruding portions 112 helps the heating member 10 to have an atomization explosive force at each position in the axial direction and the circumferential direction, thereby further improving the atomization explosive force of the heating member 10.

The recessed portions 111 or the protruding portions 112 may be the same or different, or may be partially the same and partially different in terms of a shape, a structure, and a size. The same parts include a difference caused by a factor such as a manufacturing tolerance. A structure of the recessed portion 111 or the protruding portion 112 may be a curved surface structure, such as a U-shaped structure. Alternatively, the recessed portion 111 or the protruding portion 112 includes a first wall surface 118 and a second wall surface 119 that are disposed opposite to each other. The first wall surface 118 and the second wall surface 119 each are a plane. The first wall surface 118 and the second wall surface 119 are connected and disposed opposite to each other, so that the first wall surface 118 and the second wall surface 119 can radiate toward each other. Each of the first wall surface 118 and the second wall surface 119 may be at least one shape of a plane and a curved surface.

Refer to FIG. 5. When the recessed portion 111 or the protruding portion 112 includes the first wall surface 118 and the second wall surface 119, an included angle is formed between the first wall surface 118 and the second wall surface 119. The included angle may range from 10° to 130°, for example, the included angle may be 10° or 130°. When in the included angle range, the first wall surface 118 and the second wall surface 119 are relatively closer to each other, a mutual radiation effect between the first wall surface 118 and the second wall surface 119 is better, and an effect of the atomization explosive force is better.

In an embodiment, as shown in FIG. 4 and FIG. 5, the heating portion 11 further includes a main body portion 1139. The main body portion 1139 is connected to the recessed portion 111 and/or the protruding portion 112, and the main body portion 1139 is parallel to the axial direction of the tubular structure. Disposing the main body portion 1139 can ensure that at least a part of the heating portion 11 can be fully attached to the inner surface of the sleeve 30, thereby facilitating flow of an aerosol generation substrate onto a surface of the heating portion 11. In addition, that the main body portion 1139 is parallel to the axial direction of the tubular structure represents that a surface of the main body portion 1139 is a regular plane, which facilitates flow of the aerosol generation substrate on the heating portion 11 and plays a role of guiding the flow of the aerosol generation substrate.

That the main body portion 1139 is connected to the recessed portion 111 and/or the protruding portion 112 may mean that, in the plurality of recessed portions 111, adjacent recessed portions 111 are connected by using the main body portion 1139; or in the plurality of protruding portions 112, adjacent protruding portions 112 are connected by using the main body portion 1139; or in the plurality of recessed portions 111 and the plurality of protruding portions 112, the recessed portion 111 is connected to the protruding portion 112 by using the main body portion 1139; or one or more recessed portions 111 and one or more protruding portions 112 are divided into one group, and groups may be connected to each other by using the main body portion 1139.

In an embodiment, as shown in FIG. 4, the heating portion 11 may be a mesh structure. The heating portion 11 includes a plurality of heating units 113. For example, in FIG. 3 and FIG. 4, a heating unit 113 is a diamond shape. The heating unit 113 is provided with a hollowed-out hole 114, and the plurality of heating units 113 are arranged in an array and connected to each other to form the mesh structure. The hollowed-out hole 114 enables an aerosol generation substrate to diffuse from an outer surface of the heating portion 11 to an inner surface of the heating portion 11, thereby increasing an atomization area of the heating member 10. The mesh structure formed by the heating units 113 arranged in an array and connected to each other can enhance connectivity between the heating units 113, so as to improve heat transfer efficiency, thereby increasing the TPM of the atomization apparatus.

In an embodiment, at least one heating unit 113 includes the recessed portion 111 and/or the protruding portion 112. For example, in FIG. 3 and FIG. 4, each heating unit 113 includes the recessed portion 111. In FIG. 5, a part between a dashed line A and a dashed line B may be considered as a heating unit 113, and each heating unit 113 includes a recessed portion 111. In FIG. 6, a part between a dashed line A and a dashed line B is considered as a first heating unit 1131 with the protruding portion 112, and a part between a dashed line B and a dashed line C is considered as a second heating unit 1132 with the recessed portion 111. FIG. 6 is a schematic diagram in which the first heating unit 1131 with the protruding portion 112 and the second heating unit 1132 with the recessed portion 111 are alternately connected.

In an embodiment, the recessed portion 111 or the protruding portion 112 may alternatively be formed through connection of at least a part of adjacent heating units 113. For example, in FIG. 7, a structure between a dashed line A and a dashed line B is a third heating unit 1133, and a structure between a dashed line B and a dashed line C is a fourth heating unit 1134. The third heating unit 1133 and the fourth heating unit 1134 are connected to form one recessed portion 111.

In an embodiment, as shown in FIG. 4, the heating unit 113 includes a first heating portion 1135, a second heating portion 1136, a third heating portion 1137, and a fourth heating portion 1138. The first heating portion 1135, the second heating portion 1136, the third heating portion 1137, and the fourth heating portion 1138 are sequentially connected head-to-tail to form a diamond shape. Each diamond shape includes an upper endpoint 15, a lower endpoint 16, a left endpoint 17, and a right endpoint 18. Adjacent diamonds may be connected at endpoints. When the recessed portion 111 or the protruding portion 112 includes the first wall surface 118 and the second wall surface 119, the first wall surface 118 and the second wall surface 119 are connected and disposed opposite to each other. The upper endpoint 15 and the lower endpoint 16, and either the left endpoint 17 or the right endpoint 18 of the diamond-shaped structure are located at a connection position between the first wall surface 118 and the second wall surface 119. Certainly, in another embodiment, the heating unit 113 may alternatively not be a diamond shape, or may be another shape.

In an embodiment, as shown in FIG. 3 and FIG. 4, in an axial direction of the heating member 10, the heating member 10 includes a plurality of rows of heating unit groups 19, and each row of heating unit groups 19 includes a plurality of heating units 113 sequentially connected in a circumferential direction of the heating member 10. Compared with a single row of heating unit groups 19 in a conventional technology, the plurality of rows of heating unit groups 19 enable the heating member 10 to have a longer length in the axial direction, thereby increasing a radiation area of an actual heating region, so as to achieve a characteristic of high-power heating.

In an embodiment, as shown in FIG. 4, the heating portion includes the main heating portion 50 and the wiring portion 12. The main heating portion 50 may include, for example, the recessed portion 111 and/or the protruding portion 112 and the main body portion 1139 described above. A connection position between the main heating portion 50 and the wiring portion 12 is provided with a thermal stress relief hole 115. Disposing the thermal stress relief hole 115 can improve a problem of fatigue fracture at an edge portion of the heating member 10 caused by thermal deformation of the heating member 10 during a heating process.

In an embodiment, as shown in FIG. 4, the heating member 10 includes the main heating portion 50 and a plurality of heat conducting portions 13. In the axial direction of the heating member 10, the main heating portion 50 has a first end 116 and a second end 117 that are opposite to each other. The heat conducting portions 13 are connected to the first end 116 and/or the second end 117 of the main heating portion 50, and the heat conducting portions 13 extend in the axial direction of the heating member 10. Excess heat of the heating portion 11 may flow from the heating portion 11 to the heat conducting portions 13, thereby improving heat utilization efficiency of the heating member 10 and increasing an atomization capacity of the atomization apparatus.

What is claimed is:

1. A heating member, wherein the heating member comprises:
a heating portion, wherein the heating portion is wound and enclosed to form a tubular structure, the heating portion is provided with a plurality of recessed portions or a plurality of protruding portions that are capable of causing secondary radiation of heat, the recessed portions are bent inward in a radial direction of the tubular structure, and the protruding portions are bent outward in the radial direction of the tubular structure; and
an electrode portion, wherein the electrode portion is connected to the heating portion.

2. The heating member according to claim 1, wherein the plurality of recessed portions or the plurality of protruding portions are disposed at intervals; or in the plurality of recessed portions and the plurality of protruding portions, the recessed portions and the protruding portions are alternately disposed.

3. The heating member according to claim 2, wherein the heating portion further comprises a main body portion, the main body portion is connected to the recessed portion or the protruding portion, and the main body portion is parallel to an axial direction of the tubular structure.

4. The heating member according to claim 1, wherein the heating portion is a mesh structure, the heating portion comprises a plurality of heating units, the heating unit is provided with a hollowed-out hole, and a plurality of the heating units are arranged in an array and connected to each other to form the mesh structure.

5. The heating member according to claim 4, wherein the heating unit is a diamond-shaped structure, and adjacent diamond-shaped structures are connected at endpoints; and the diamond-shaped structure comprises an upper endpoint, a lower endpoint, a left endpoint, and a right endpoint, the recessed portion or the protruding portion comprises a first wall surface and a second wall surface, the first wall surface and the second wall surface are connected and disposed opposite to each other, and the upper endpoint and the lower endpoint, and either the left endpoint or the right endpoint of the diamond-shaped structure are located at a connection position between the first wall surface and the second wall surface.

6. The heating member according to claim 1, wherein the recessed portion or the protruding portion comprises a first wall surface and a second wall surface, the first wall surface and the second wall surface are connected and disposed opposite to each other; or the recessed portion or the protruding portion is a curved surface structure.

7. The heating member according to claim 6, wherein the recessed portion or the protruding portion comprises the first wall surface and the second wall surface, an included angle is formed between the first wall surface and the second wall surface, and the included angle ranges from 10° to 130°.

8. The heating member according to claim 4, wherein in an axial direction of the heating member, the heating member comprises a plurality of rows of heating unit groups, and each row of heating unit groups comprises a plurality of heating units sequentially connected in a circumferential direction of the heating member.

9. The heating member according to claim 1, wherein the heating portion comprises a main heating portion and a wiring portion, the main heating portion is provided with a plurality of recessed portions or protruding portions, the electrode portion is connected to the wiring portion, and a thermal stress relief hole is provided at a connection position between the main heating portion and the wiring portion.

10. The heating member according to claim 1, wherein the heating portion comprises a main heating portion and a plurality of heat conducting portions, and the main heating portion is provided with a plurality of recessed portions or protruding portions; and in an axial direction of the heating member, the main heating portion has a first end and a second end that are opposite to each other, the heat conducting portions are connected to the first end or the second end of the main heating portion, and the heat conducting portions extend in the axial direction of the heating member.

11. An atomization apparatus, comprising a heating member, wherein the heating member comprises:
a heating portion, wherein the heating portion is wound and enclosed to form a tubular structure, the heating portion is provided with a plurality of recessed portions or a plurality of protruding portions that are capable of causing secondary radiation of heat, the recessed portions are bent inward in a radial direction of the tubular structure, and the protruding portions are bent outward in the radial direction of the tubular structure; and
an electrode portion, wherein the electrode portion is connected to the heating portion.

12. The atomization apparatus according to claim 11, wherein the plurality of recessed portions or the plurality of protruding portions are disposed at intervals; or in the plurality of recessed portions and the plurality of protruding portions, the recessed portions and the protruding portions are alternately disposed.

13. The atomization apparatus according to claim 12, wherein the heating portion further comprises a main body portion, the main body portion is connected to the recessed portion or the protruding portion, and the main body portion is parallel to an axial direction of the tubular structure.

14. The atomization apparatus according to claim 11, wherein the heating portion is a mesh structure, the heating portion comprises a plurality of heating units, the heating unit is provided with a hollowed-out hole, and a plurality of the heating units are arranged in an array and connected to each other to form the mesh structure.

15. The atomization apparatus according to claim 14, wherein the heating unit is a diamond-shaped structure, and adjacent diamond-shaped structures are connected at endpoints; and the diamond-shaped structure comprises an upper endpoint, a lower endpoint, a left endpoint, and a right endpoint, the recessed portion or the protruding portion comprises a first wall surface and a second wall surface, the first wall surface and the second wall surface are connected and disposed opposite to each other, and the upper endpoint and the lower endpoint, and either the left endpoint or the right endpoint of the diamond-shaped structure are located at a connection position between the first wall surface and the second wall surface.

16. The atomization apparatus according to claim 11, wherein the recessed portion or the protruding portion comprises a first wall surface and a second wall surface, the first wall surface and the second wall surface are connected and disposed opposite to each other; or the recessed portion or the protruding portion is a curved surface structure.

17. The atomization apparatus according to claim 16, wherein the recessed portion or the protruding portion comprises the first wall surface and the second wall surface, an included angle is formed between the first wall surface and the second wall surface, and the included angle ranges from 10° to 130°.

18. The atomization apparatus according to claim 11, wherein the heating portion comprises a main heating portion and a wiring portion, the main heating portion is provided with a plurality of recessed portions or protruding portions, the electrode portion is connected to the wiring portion, and a thermal stress relief hole is provided at a connection position between the main heating portion and the wiring portion.

19. The atomization apparatus according to claim 11, further comprising a liquid storage member, a sleeve, and a liquid guide member, wherein the liquid storage member, the sleeve, the heating member, and the liquid guide member are sequentially nested from the outside to the inside, the sleeve is provided with a liquid inlet hole, two sides of the liquid inlet hole respectively communicate with the heating member and the liquid storage member, a heating portion of the heating member is provided with a plurality of recessed portions, and at least a part of the recessed portion is inserted into the liquid guide member.

20. The atomization apparatus according to claim 19, wherein an aerosol generation substrate is atomized into aerosol in the sleeve, one end of the sleeve is an aerosol outlet of the sleeve, the other end of the sleeve is provided with an air inlet, a side of the sleeve close to the air inlet is provided with a plurality of liquid inlet holes, and the heating member is disposed at an end of the sleeve provided with the liquid inlet holes.
